(19) United States
(12) Patent Application Publication
(10) Pub. No.: US 2016/0127524 A1
(43) Pub. Date: May 5, 2016

(54) ELECTRONIC APPARATUS

(71) Applicant: KYOCERA Corporation, Kyoto-shi (JP)

(72) Inventors: Yasuhito Kanemaki, Osaka (JP); Kotaro Nakamura, Osaka (JP)

(73) Assignee: Kyocera Corporation

(21) Appl. No.: 14/994,066

(22) Filed: Jan. 12, 2016

Related U.S. Application Data
(63) Continuation of application No. PCT/JP2014/067154, filed on Jun. 27, 2014.

(30) Foreign Application Priority Data
Jul. 18, 2013 (JP) 2013-149001

(51) Int. Cl. H04M 1/02; H04B 1/3827

(52) U.S. Cl. CPC H04M 1/0266; H04B 1/3827

(57) ABSTRACT

An electronic apparatus is disclosed. An electronic apparatus comprises a display, a cover member, a first portion configured to vibrate more easily than the cover member, a piezoelectric vibrating element, and a controller. The cover member is located on a surface of the electronic apparatus and is configured to cover a display surface of the display. The first portion is located on the surface of the electronic apparatus. The piezoelectric vibrating element is located on the first portion. The controller is configured to cause the piezoelectric vibrating element to vibrate based on a sound signal.

### CROSS-REFERENCE TO RELATED APPLICATION

The present application is a continuation based on PCT Application No. PCT/JP2014/067154, filed on Jun. 27, 2014, which claims the benefit of Japanese Application No. 2013-149001, filed on Jul. 18, 2013. PCT Application No. PCT/JP2014/067154 is entitled “ELECTRONIC APPARATUS”, and Japanese Application No. 2013-149001 is entitled “ELECTRONIC APPARATUS”. The contents of which are incorporated by reference herein in their entirety.

### FIELD

Embodiments of the present disclosure relate to an electronic apparatus.

### BACKGROUND

Various technologies have conventionally been proposed for electronic apparatuses.

### SUMMARY

An electronic apparatus is disclosed. In one embodiment, an electronic apparatus comprises a display, a cover member, a first portion configured to vibrate more easily than the cover member, a piezoelectric vibrating element, and a controller. The cover member is located on a surface of the electronic apparatus and is configured to cover a display surface of the display. The first portion is located on the surface of the electronic apparatus. The piezoelectric vibrating element is located on the first portion. The controller is configured to cause the piezoelectric vibrating element to vibrate based on a sound signal.

### BRIEF DESCRIPTION OF THE DRAWINGS

FIG. 1 illustrates a perspective view showing an external appearance of an electronic apparatus according to an embodiment 1.

FIG. 2 illustrates a front view showing the external appearance of the electronic apparatus according to the embodiment 1.

FIG. 3 illustrates a rear view showing the external appearance of the electronic apparatus according to the embodiment 1.

FIG. 4 illustrates a plan view showing a cover member when seen from its inner surface side.

FIG. 5 illustrates an electrical configuration of the electronic apparatus according to the embodiment 1.

FIG. 6 illustrates a top view showing a structure of a piezoelectric vibrating element.

FIG. 7 illustrates a side view showing the structure of the piezoelectric vibrating element.

FIG. 8 illustrates how the piezoelectric vibrating element vibrates while being bent.

FIG. 9 illustrates how the piezoelectric vibrating element vibrates while being bent.

FIG. 10 illustrates a sectional structure of the electronic apparatus according to the embodiment 1.

FIG. 11 illustrates a partially-enlarged sectional structure of the electronic apparatus according to the embodiment 1.

FIG. 12 illustrates a view for describing air conduction sound and tissue conduction sound.

FIG. 13 illustrates a partially-enlarged sectional structure of an electronic apparatus according to a modification of the embodiment 1.

FIG. 14 illustrates a partially-enlarged sectional structure of an electronic apparatus according to an embodiment 2.

FIG. 15 illustrates a plan view showing a part of a structure of an electronic apparatus according to the embodiment 2.

FIG. 16 illustrates a plan view showing a partially-enlarged sectional structure of an electronic apparatus according to a modification of the embodiment 2.

FIG. 17 illustrates a plan view showing a part of a structure of the electronic apparatus according to a modification of the embodiment 2.

### DETAILED DESCRIPTION

### Embodiment 1

### External Appearance of Electronic Apparatus

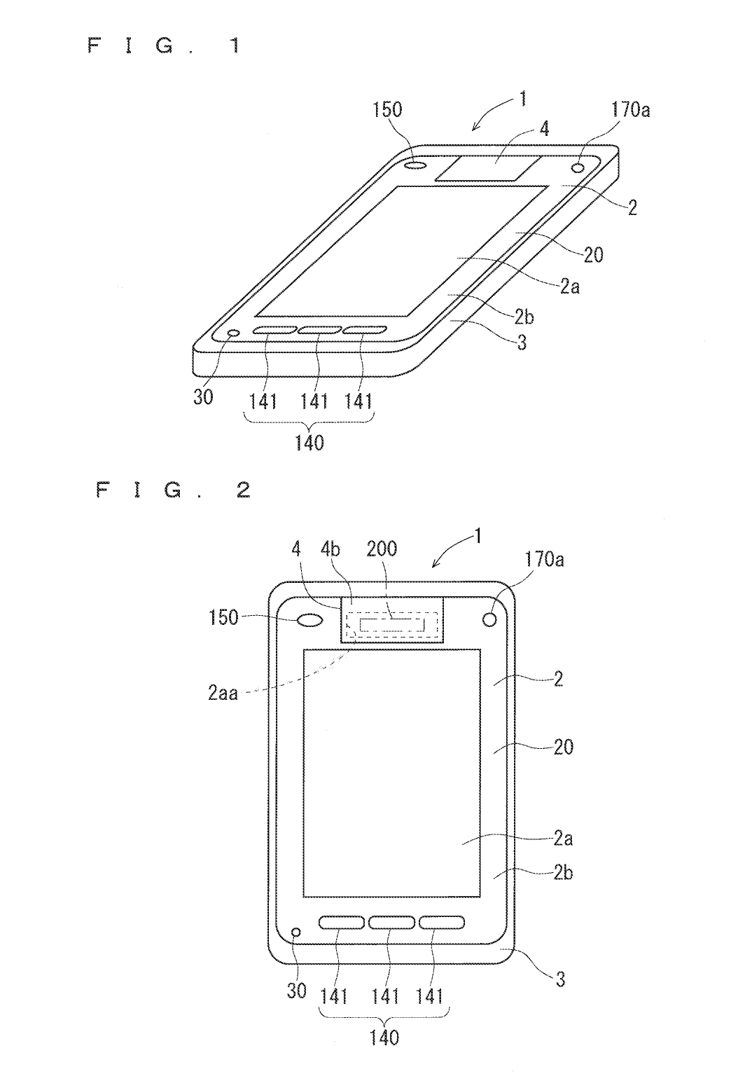

FIGS. 1 to 3 are a perspective view, a front view, and a rear view, respectively, showing the external appearance of an electronic apparatus 1 according to an embodiment 1. FIG. 4 is a rear view showing a cover member 2 of the electronic apparatus 1. The electronic apparatus 1 according to one embodiment is, for example, a mobile phone.

As illustrated in FIGS. 1 to 3, the electronic apparatus 1 includes the cover member (also referred to as a cover panel) 2 that covers the display surface of a display panel 120, which will be described below, and a housing 3 that accommodates respective elements such as the display panel 120 and the like of the electronic apparatus 1. The cover member 2 and the housing 3 are combined, so that the electronic apparatus 1 has an approximately rectangular plate shape in a plan view.

The cover member 2 has a plate shape. In a plan view, the cover member 2 has an approximately rectangular shape. The cover member 2 forms the front portion, except the peripheral portion of the front portion, of the electronic apparatus 1. The cover member 2 is made of a material that is transparent and relatively hard. Such material may be, for example, glass (tempered glass) or sapphire (artificial sapphire). Here, sapphire is made of aluminum oxide (AlO₃) crystals and industrially manufactured. Sapphire may be a single crystal or a polycrystal as long as it is transparent. A sapphire single crystal refers to an alumina (Al₂O₃) single crystal and, herein, refers to a single crystal having a purity of Al₂O₃ of approximately 90% or more. The purity of Al₂O₃ is preferably equal to or greater than 99% which provides a greater resistance to damage of the cover member and more reliably eliminates or reduces cracks or chipping.

The housing 3 has an approximately rectangular parallelepiped shape with one of its surfaces being partially open. The housing 3 forms the peripheral portion of the front portion, the side portion, and the rear portion of the electronic apparatus 1. The housing 3 is made of, for example, resin. The resin forming the housing 3 may be, for example, a polycarbonate resin, an ABS resin, or a nylon-based resin. The housing 3 may include a single member or a plurality of members combined therein.

The cover member 2 includes a transparent display portion (also referred to as a display window) 2a transmitting the display of the display panel 120. The display portion 2a has, for example, a rectangular shape in a plan view. The visible light output from the display panel 120 passes through the display portion 2a and is emitted to the outside of the electronic apparatus 1. The user visually recognizes information displayed on the display panel 120 through the display portion 2a from the outside of the electronic apparatus 1. A peripheral portion 2b of the cover member 2 that surrounds the display portion 2a is opaque and/or not transparent because of, for example, a film or the like is attached thereto. Accordingly, the peripheral portion 2b is a non-display portion that does not transmit the display of the display panel 120. A touch panel 130, which will be described below, is attached to an inner surface 21 (see FIG. 4) of the cover member 2. The user can provide various instructions to the electronic apparatus 1 by operating the display portion 2a of the cover member 2 using the finger or the like.

Provided in the inside of the housing 3 is an operation unit 140 including a plurality of hardware keys 141. The surface of each hardware key 141 is exposed from the lower end of an outer surface 20 of the cover member 2. As illustrated in FIG. 4, provided at the lower end of the cover member 2 are a plurality of holes 22 that allow the corresponding ones of the plurality of hardware keys 141 to be exposed. Three hardware keys 141 are located in the electronic apparatus 1 according to one embodiment, but the number of the hardware keys 141 may be changed as appropriate.

Provided at the lower end of the cover member 2 is a microphone hole 30. An imaging lens 170a of a front imaging unit 170 which will be described below and a proximity sensor 150 which will be described below can be visually recognized from the upper end of the outer surface 20 of the cover member 2.

As illustrated in FIGS. 2 and 4, provided at the upper end of the cover member 2 is an opening 2aa that penetrates the cover member 2 in the thickness direction. The opening 2aa is provided on a central portion in the horizontal direction of the upper end of the cover member 2. The opening 2aa is provided in the peripheral portion 2b (the non-display portion) of the cover member 2. The opening 2aa has, for example, a rectangular shape in a plan view. The longitudinal direction of the opening 2aa corresponds to the horizontal direction of the cover member 2.

The outer surface (front surface) 20 of the cover member 2 is provided with a panel 4 that covers the opening 2aa. The panel 4 is located on the surface of the electronic apparatus 1, more specifically, the front surface of the electronic apparatus 1. A rear surface 4a of the panel 4 is provided with a piezoelectric vibrating element 200, which will be described below. The panel 4 vibrates due to the vibrations created by the piezoelectric vibrating element 200. Thus, as described below, sound comes out of the panel 4. The panel 4 has, for example, a rectangular plate shape in a plan view. The longitudinal direction of the panel 4 corresponds to the horizontal direction of the cover member 2 and the longitudinal direction of the opening 2aa.

As a whole, the panel 4 vibrates more easily than the cover member 2. Thus, the piezoelectric vibrating element 200 is located in a portion that is located on the surface of the electronic apparatus 1 and vibrates more easily than the cover member 2. The expression of “a member vibrates more easily than the cover member 2” means that, in response to the vibrations of the piezoelectric vibrating element 200, the relevant member vibrates more than the cover member 2 and generates sound waves more easily than the cover member 2. To accurately determine whether a member provided with the piezoelectric vibrating element 200 vibrates more easily than the cover member 2, the piezoelectric vibrating element 200 is attached to each of the relevant member and the cover member 2, and then, sound pressure is measured while the relevant member and the cover member 2 vibrate. Instead of performing such measurement, the hardness (such as Young's modulus) may be measure with respect to the relevant member and the cover member 2 for comparison on which member vibrates more easily. The hardness can be measured by the ordinary measurement method.

The panel 4 is made of, for example, a material softer than that of the cover member 2. That is, the cover member 2 has a Young's modulus greater than that of the panel 4. The panel 4 is made of, for example, an acrylic resin or a polycarbonate resin. The rear surface 4a of the panel 4 is printed in such a manner that the piezoelectric vibrating element 200 attached to the rear surface 4a of the panel 4 is not visually recognized from the front surface side of the electronic apparatus 1.

The panel 4 may be colored in such a manner that the piezoelectric vibrating element 200 attached to the rear surface 4a of the panel 4 is not visually recognized from the front surface side of the electronic apparatus 1. Alternatively, a front surface 4b and the shape of the panel 4 may have designs such that the panel 4 is used as a design panel. The panel 4 may have a shape other than a rectangular shape. The panel 4 may have, for example, a round shape.

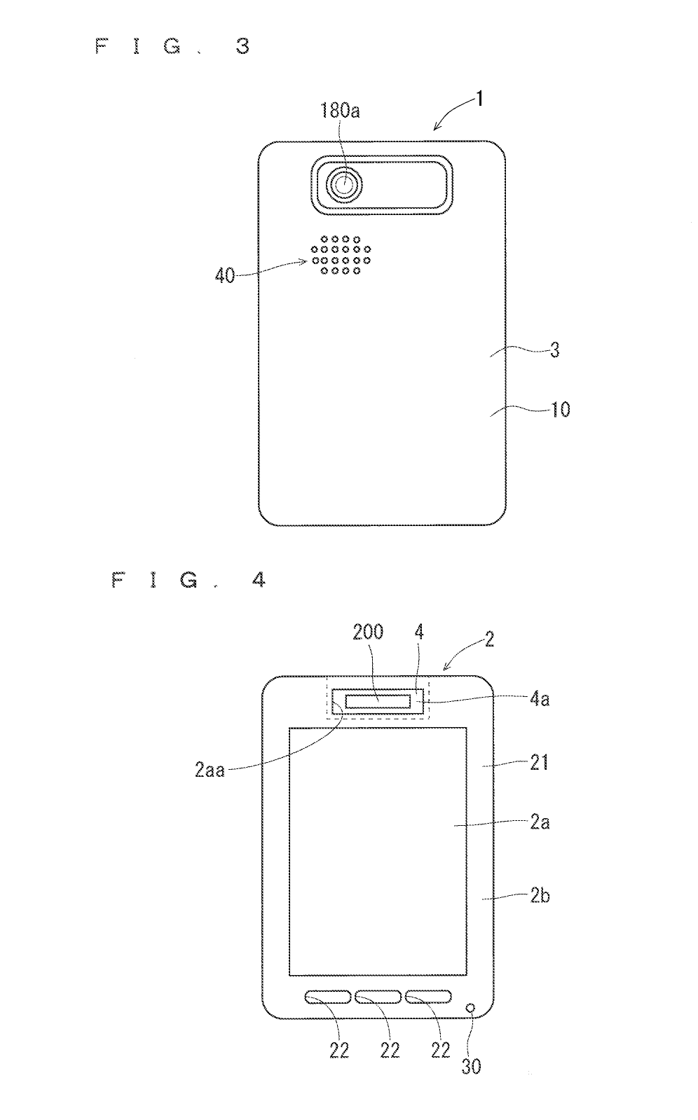

As illustrated in FIG. 3, provided on a rear surface 10 of the electronic apparatus 1, in other words, on the rear surface of the housing 3, are speaker holes 40. Through the rear surface 10 of the electronic apparatus 1, an imaging lens 180a of a rear imaging unit 180, which will be described below, can be visually recognized.

<Electrical Configuration of Electronic Apparatus>

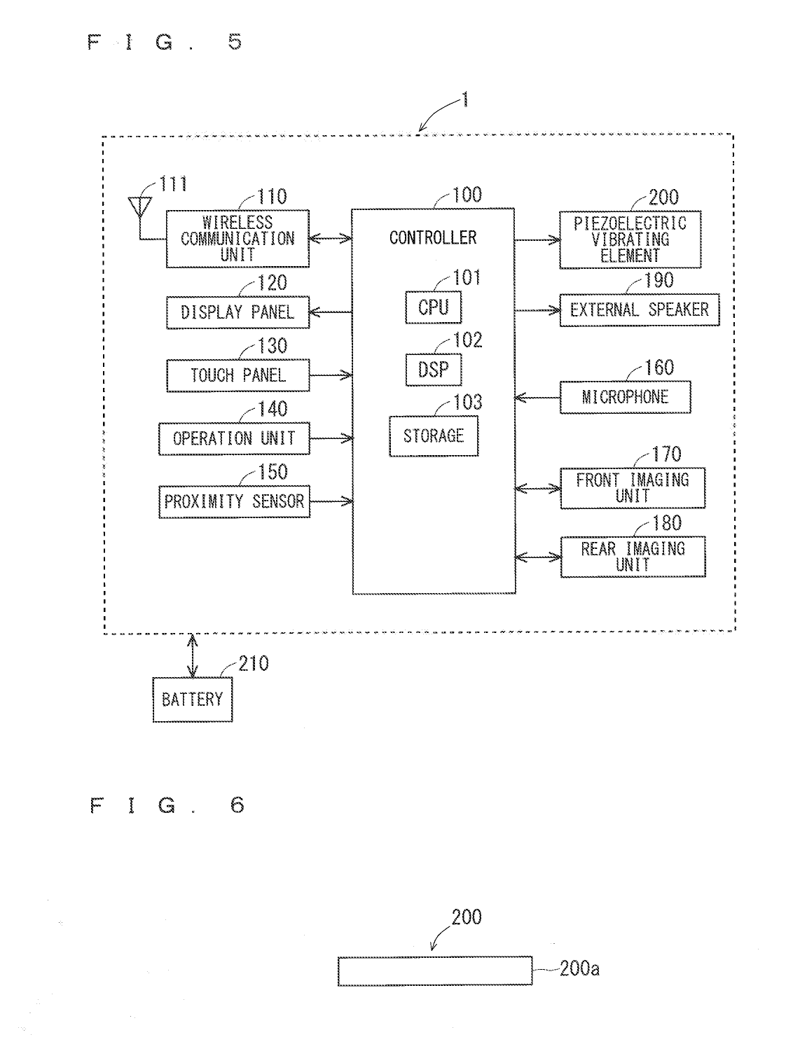

FIG. 5 is a block diagram mainly illustrating the electrical configuration of the electronic apparatus 1. As illustrated in FIG. 5, the electronic apparatus 1 includes a controller 100, a wireless communication unit 110, the display panel 120, the touch panel 130, the operation unit 140, and the proximity sensor 150. The electronic apparatus 1 further includes a microphone 160, the front imaging unit 170, the rear imaging unit 180, an external speaker 190, the piezoelectric vibrating element 200, and a battery 210. The housing 3 accommodates the respective elements, except for the cover member 2, of the electronic apparatus 1.

The controller 100 includes a Central Processing Unit (CPU) 101, a Digital Signal Processor (DSP) 102, and a storage 103. The controller 100 can manage the overall operation of the electronic apparatus 1 by controlling other elements of the electronic apparatus 1. The storage 103 is, for example, a Read Only Memory (ROM) or a Random Access Memory (RAM). A main program, a plurality of application programs, and the like are stored in the storage 103, the main program being a control program for controlling the electronic apparatus 1, specifically, for controlling respective elements such as the wireless communication unit 110, the display panel 120, and the like of the electronic apparatus 1. Various functions of the controller 100 can be enabled by the CPU 101 and the DSP 102 by executing various programs in the storage 103.

The wireless communication unit 110 includes an antenna 111. In the wireless communication unit 110, the antenna 111 can receive a signal from a mobile phone different from the electronic apparatus 1, or from a communication device such as a web server connected to the Internet via a base station. The wireless communication unit 110 can perform an amplification process and down conversion on the received signal and output the signal to the controller 100. The controller 100 can perform demodulation processing or the like on the input signal, and acquire a sound signal (sound information) indicating a voice or music included in the received signal.

The wireless communication unit 110 can perform up-converting and the amplification process on a transmission signal including a sound signal or the like generated in the controller 100, and wirelessly transmit the transmission signal after the process from the antenna 111. The transmission signal from the antenna 111 can be received in a communication device connected to the Internet or a mobile phone different from the electronic apparatus 1 via the base station.

The display panel 120 being a display is, for example, a liquid crystal display panel or an organic electro luminescent (EL) panel. The display panel 120 can display various pieces of information such as characters, symbols, and figures by control of the controller 100. The information displayed in the display panel 120 can be visually recognized by the user of the electronic apparatus 1 through the display portion 2a of the cover member 2.

The touch panel 130 is, for example, a projection type electrostatic capacitance touch panel. The touch panel 130 can detect contact of an object with respect to the display portion 2a of the cover member 2. The touch panel 130 is attached to the inner surface of the cover member 2. The touch panel 130 includes two sheet-shaped electrode sensors opposed to each other. The two electrode sensors are bonded to each other through a transparent adhesive sheet.

Formed in one of the electrode sensors are a plurality of long and narrow X electrodes that extend along an X-axis direction (for example, the horizontal direction of the electronic apparatus 1) and are disposed parallel to one another. Formed in the other electrode sensor are a plurality of long and narrow Y electrodes that extend along a Y-axis direction (for example, the vertical direction of the electronic apparatus 1) and are disposed parallel to one another. When the finger or the like of the user contacts the display portion 2a of the cover member 2, the capacitance between the X electrode and the Y electrode below the contacted portion changes. Thus, the touch panel 130 can detect an operation (contact) of the cover member 2 with the display portion 2a. The touch panel 130 can generate an electrical signal indicating the capacitance change between the X electrode and the Y electrode and output the electrical signal to the controller 100. The controller 100 can specify the details of an operation performed on the display portion 2a of the cover member 2 based on the electrical signal and perform an operation according to the specified details.

For each of the plurality of hardware keys 141, when the user presses the hardware key 141, the operation unit 140 can output, to the controller 100, an operation signal indicating that the hardware key 141 has been pressed. The controller 100 can identify, based on an operation signal to be input, which hardware key 141 of the plurality of hardware keys 141 has been operated, and then perform the operation according to the hardware key 141 that has been operated.

The proximity sensor 150 is, for example, an infrared type proximity sensor. The proximity sensor 150 can output a detection signal when an object approaches the proximity sensor 150 within a predetermined distance. The detection signal is input to the controller 100. When the controller 100 receives the detection signal from the proximity sensor 150, for example, the controller 100 can stop a function of detecting an operation of the touch panel 130.

The front imaging unit 170 includes the imaging lens 170a, an imaging element, and the like. The front imaging unit 170 can image a still image and a moving image based on the control by the controller 100. As illustrated in FIGS. 1 and 2, the imaging lens 170a is disposed in such a manner that the imaging lens 170a can be visually recognized from the front surface of the electronic apparatus 1. Therefore, the front imaging unit 170 can image an object in front of the surface side (cover member 2 side) of the electronic apparatus 1.

The rear imaging unit 180 includes the imaging lens 180a, an imaging element, and the like. The rear imaging unit 180 can image a still image and a moving image based on the control by the controller 100. As illustrated in FIG. 3, the imaging lens 180a is disposed in such a manner that the imaging lens 180a can be visually recognized from the rear surface 10 of the electronic apparatus 1. Therefore, the rear imaging unit 180 can image an object in front of the rear surface 10 side of the electronic apparatus 1.

The microphone 160 can output a sound from the outside of the electronic apparatus 1 to the controller 100 by converting the sound into an electric sound signal. The sound from the outside of the electronic apparatus 1 is received by the microphone 160 through the microphone hole 30 provided on the front surface of the cover member 2. The microphone hole 30 may be provided on the side surface of the electronic apparatus 1 or may be provided on the rear surface 10.

The external speaker 190 is, for example, a dynamic speaker. The external speaker 190 can convert an electric sound signal from the controller 100 into a sound and then output the sound. The sound output from the external speaker 190 is output from the speaker holes 40 located on the rear surface 10 of the electronic apparatus 1 to the outside. The volume of the sound output from the speaker holes 40 can be set to a degree such that the sound can be heard at a location separated from the electronic apparatus 1.

The piezoelectric vibrating element 200 is attached to the rear surface of the panel 4 disposed on the front surface of the electronic apparatus 1. The piezoelectric vibrating element 200 can be vibrated by a drive voltage provided from the controller 100. The controller 100 can generate a drive voltage based on a sound signal, and provide the drive voltage to the piezoelectric vibrating element 200. The piezoelectric vibrating element 200 is vibrated by the controller 100 based on a sound signal, and accordingly the panel 4 is vibrated based on the sound signal. Consequently, a reception signal is transmitted from the panel 4 to the user. The volume of the reception sound can be set to a degree such that the user can hear the sound when moving the panel 4 close to an ear. The reception sound transmitted from the panel 4 to the user will be described below in detail.

The battery 210 can output the power for the electronic apparatus 1. The power output from the battery 210 is supplied to the respective electronic components such as the controller 100 and the wireless communication unit 110 of the electronic apparatus 1.

<Details of Piezoelectric Vibrating Element>

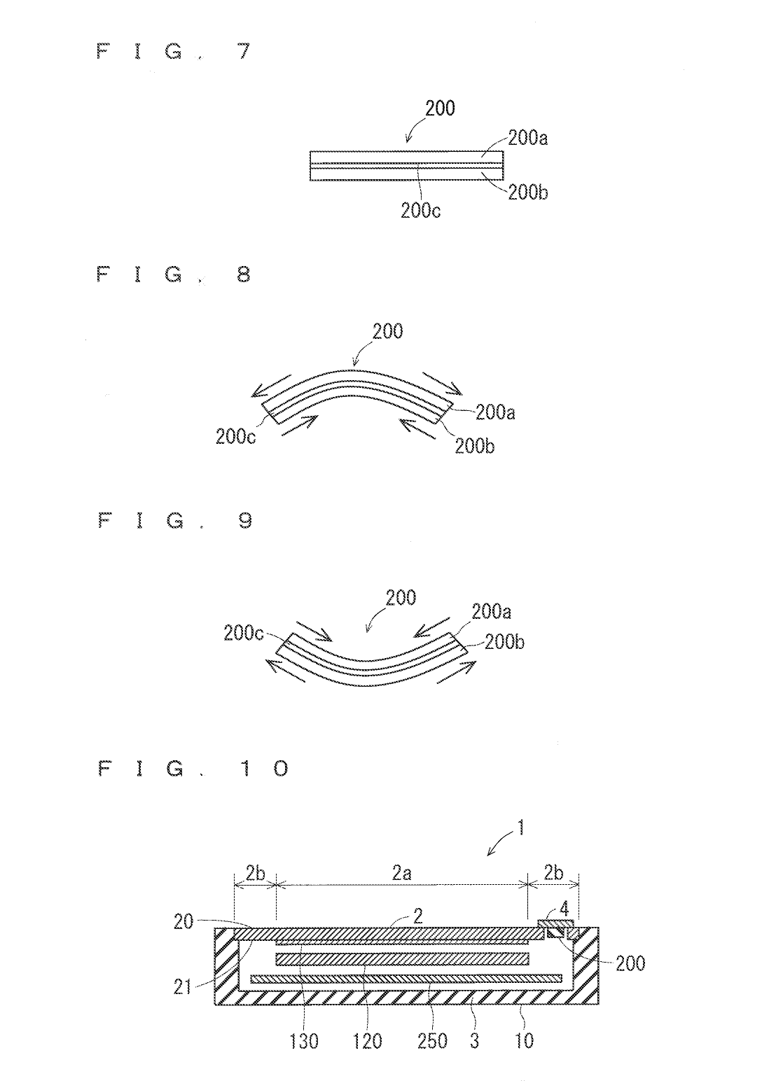

FIGS. 6 and 7 are a top view and a side view, respectively, illustrating a structure of the piezoelectric vibrating element 200. As illustrated in FIGS. 6 and 7, the piezoelectric vibrating element 200 has a long shape in one direction. Specifically, the piezoelectric vibrating element 200 has a long and narrow rectangular plate shape in a plan view. The piezoelectric vibrating element 200 has, for example, a bimorph structure. The piezoelectric vibrating element 200 includes a first piezoelectric ceramic plate 200a and a second piezoelectric ceramic plate 200b which are bonded to each other through a shim material 200c therebetween.

In the piezoelectric vibrating element 200, when a positive voltage is applied to the first piezoelectric ceramic plate 200a and a negative voltage is applied to the second piezoelectric ceramic plate 200b, the first piezoelectric ceramic plate 200a extends along the longitudinal direction and the second piezoelectric ceramic plate 200b contracts along the longitudinal direction. Accordingly, as illustrated in FIG. 8, the piezoelectric vibrating element 200 is bent into a convex with the first piezoelectric ceramic plate 200a being the outside.

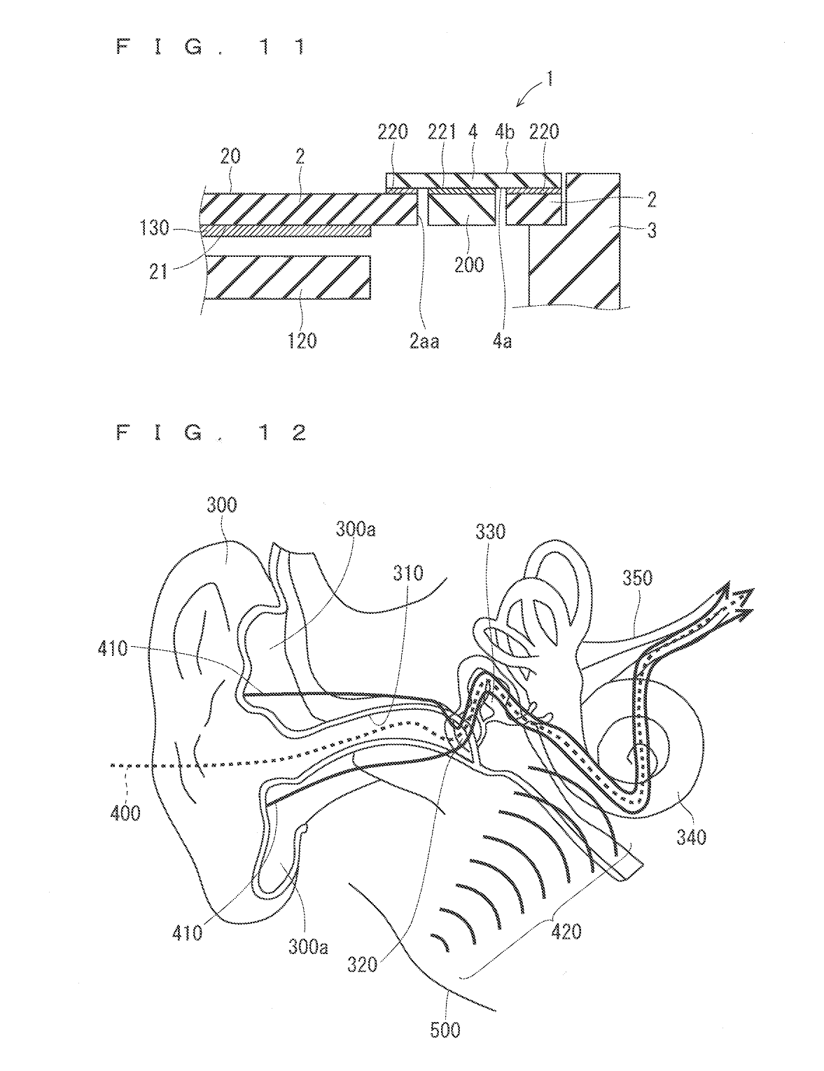

In contrast, in the piezoelectric vibrating element 200, when a negative voltage is applied to the first piezoelectric ceramic plate 200a and a positive voltage is applied to the second piezoelectric ceramic plate 200b, the first piezoelectric ceramic plate 200a contracts along the longitudinal direction and the second piezoelectric ceramic plate 200b extends along the longitudinal direction. Accordingly, as illustrated in FIG. 9, the piezoelectric vibrating element 200 is bent into a convex with the second piezoelectric ceramic plate 200b being the outside.

The piezoelectric vibrating element 200 vibrates while being bent by alternately taking the state of FIG. 8 and the state of FIG. 9. The controller 100 allows the piezoelectric vibrating element 200 to vibrate while being bent by applying an alternating current (AC) voltage in which a positive voltage and a negative voltage alternately appear at an area between the first piezoelectric ceramic plate 200a and the second piezoelectric ceramic plate 200b.

Only one structure made of the first piezoelectric ceramic plate 200a and the second piezoelectric ceramic plate 200b, which are bonded to each other with the shim material 200c therebetween, is located in the piezoelectric vibrating element 200 illustrated in FIGS. 6 to 9. Alternatively, a plurality of the structures may be laminated to each other.

The piezoelectric vibrating element 200 having such a structure is located on a central portion in the horizontal direction (the short-length direction perpendicular to the longitudinal direction) in the upper end of the inner surface 21 of the cover member 2, as illustrated in FIGS. 2 and 4. The longitudinal direction of the piezoelectric vibrating element 200 corresponds to the horizontal direction of the cover member 2. Further, the center of the piezoelectric vibrating element 200 in the longitudinal direction corresponds to the center in the horizontal direction of the upper end of the inner surface 21 of the cover member 2.

As illustrated in FIGS. 8 and 9 mentioned above, the center of the piezoelectric vibrating element 200 in the longitudinal direction has the largest displacement amount when the piezoelectric vibrating element 200 is vibrating while being bent. Accordingly, an area in the center in the horizontal direction of the upper end of the inner surface 21 of the cover member 2, which corresponds to the position of the piezoelectric vibrating element 200, has the largest displacement amount of bending and vibrating.

<Sectional Structure of Electronic Apparatus>

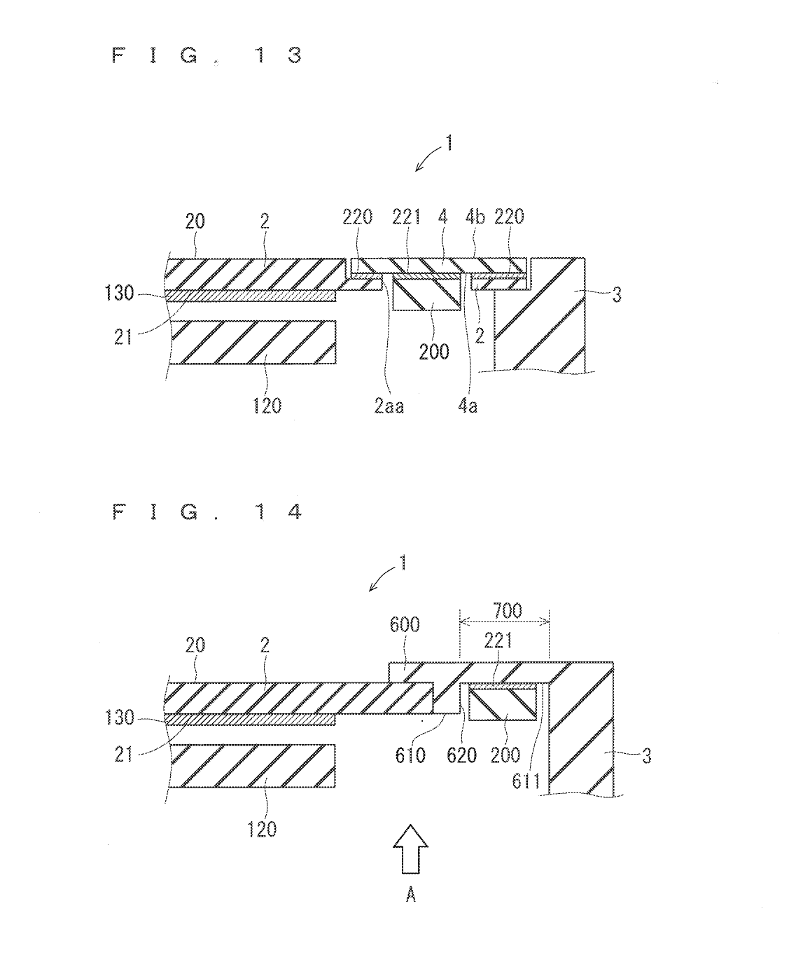

FIG. 10 schematically illustrates the sectional structure of the electronic apparatus 1 in the vertical direction (longitudinal direction). FIG. 11 is an enlarged view showing the sectional structure illustrated in FIG. 10 at and around the piezoelectric vibrating element 200. FIGS. 10 and 11 illustrate the sectional structure of the electronic apparatus 1 in a sideways position with the upper end of the electronic apparatus 1 being located on the right side.

As illustrated in FIGS. 10 and 11, the touch panel 130 is attached to the inner surface 21 of the cover member 2 so as to face the display portion 2a of the cover member 2. Further, the display panel 120 being a display is disposed so as to face the cover member 2 and the touch panel 130. A portion of the cover member 2 facing the display panel 120 is the display portion 2a.

Provided in the inside of the housing 3 is a printed circuit board 250 in which various components such as the CPU 101 and the DSP 102 are mounted. The printed circuit board 250 is disposed between the display panel 120 and the rear surface 10 of the electronic apparatus 1 so as to face the display panel 120.

As illustrated in FIG. 11, the panel 4 is attached to the outer surface 20 of the cover member 2 with a bonding material 220 so as to cover the opening 2aa provided in the cover member 2. The thickness of the panel 4 is set to be smaller than the thickness of, for example, the cover member 2.

The bonding material 220 may be a double-sided tape or an adhesive. In a case where the electronic apparatus 1 is made waterproof, a waterproof double-sided tape or a waterproof adhesive is used as the bonding material 220. The waterproof double-sided tape is, for example, a double-sided tape including a foam as a base material with an acrylic gluing agent being provided on both sides of the base material. The waterproof adhesive is, for example, an adhesive made of thermosetting resin. The waterproof double-sided tape and the waterproof adhesive are not limited to above examples.

The double-sided tape has an adhesive strength that is smaller than that of the adhesive, and thus, the use of the double-sided tape as the bonding material 220 allows the panel 4 to vibrate easily. Alternatively, the double-sided tape may be used as a part of the bonding material 220 and the adhesive may be used as the remaining part of the bonding material 220. If this is the case, the adhesive may be used as the part of the bonding material 220, which is disposed so as to surround the piezoelectric vibrating element 200, on the outer surface (front surface) of the upper end of the cover member 2 attached to the housing 3 (the portion of the bonding material 220 illustrated in FIG. 11 on the right of the piezoelectric vibrating element 200) and the double-side tape may be used as the remaining part of the bonding material 220. Accordingly, the panel 4 vibrates easily while the panel 4 is firmly attached to the cover member 2.

The piezoelectric vibrating element 200 is attached to the rear surface 4a of the panel 4 with a bonding material 221. More specifically, the piezoelectric vibrating element 200 is attached to a portion of the rear surface 4a of the panel 4 exposed from the opening 2aa of the cover member 2 with the bonding material 221. The bonding material 221 may be a double-sided tape or a waterproof adhesive. The double-sided tape used as the bonding material 221 is, for example, a double-sided tape that is impact resistant and strongly adhesive. Such a double-sided tape is, for example, a double-sided tape including a nonwoven fabric as a base material with an acrylic gluing agent being provided on both side of the base material. The use of the bonding material 221 being a double-sided tape that is impact resistant and strongly adhesive can reduce the occurrence of breakage of the piezoelectric vibrating element 200 if the electronic apparatus 1 is dropped. Further, a vibration of the piezoelectric vibrating element 200 can be transmitted to the panel 4 more easily. The double-sided tape used as the bonding material 221 is not limited to the above example.

The cover member 2 and the housing 3 may be bonded to each other with an adhesive such as a double-sided tape or an adhesive, or the cover member 2 and the housing 3 may be integrally formed. In a case where the electronic apparatus 1 is made waterproof, the bonding material that bonds the cover material 2 and the housing 3 to each other may be a waterproof double-sided tape or a waterproof adhesive. The electronic apparatus 1 can be more compact due to the integral formation of the cover material 2 and the housing 3.

<Generation of Reception Sound>

In the electronic apparatus 1 according to one embodiment, the piezoelectric vibrating element 200 causes the panel 4 to vibrate, so that the air conduction sound and the tissue conduction sound are transmitted from the panel 4 to the user. In other words, a vibration of the piezoelectric vibrating element 200 itself is transmitted to the panel 4, so that the air conduction sound and the tissue conduction sound are transmitted from the panel 4 to the user.

Here, the term “air conduction sound” is a sound recognized in the human brain by the vibrations of an eardrum due to a sound wave (air vibration) which enters an external auditory meatus hole (a so-called “ear hole”). On the other hand, the term “tissue conduction sound” is a sound recognized in the human brain by the vibration of the eardrum due to the vibration of an auricle transmitted to the eardrum. Hereinafter, the air conduction sound and the tissue conduction sound will be described in detail.

FIG. 12 is a view for describing the air conduction sound and the tissue conduction sound. FIG. 12 illustrates the structure of the ear of the user of the electronic apparatus 1. In FIG. 12, a dotted line 400 indicates a conduction path of a sound signal (sound information) while the air conduction sound is recognized in the human brain. A solid line 410 indicates a conduction path of a sound signal while the tissue conduction sound is recognized in the human brain.

When the piezoelectric vibrating element 200 mounted on the panel 4 vibrates based on the electric sound signal indicating the reception sound, the panel 4 vibrates, and a sound wave is output from the panel 4. When the user moves the panel 4 of the electronic apparatus 1 to an auricle 300 of the user by holding the electronic apparatus 1 in a hand, or the panel 4 of the electronic apparatus 1 is set to (brought into contact with) the auricle 300 of the user, the sound wave output from the panel 4 enters an external auditory meatus hole 310. The sound wave from the panel 4 travels through the external auditory meatus hole 310 and cause an eardrum 320 to vibrate. The vibration of the eardrum 320 is transmitted to an auditory ossicle 330 and the auditory ossicle 330 vibrates. In addition, the vibration of the auditory ossicle 330 is transmitted to a cochlea 340 and is converted into an electrical signal in the cochlea 340. The electrical signal is transmitted to the brain by passing through an acoustic nerve 350 and the reception sound is recognized in the brain. In this manner, the air conduction sound is transmitted from the panel 4 to the user.

Further, when the user puts the panel 4 of the electronic apparatus 1 to the auricle 300 of the user by holding the electronic apparatus 1 in a hand, the auricle 300 is vibrated by the panel 4, which is vibrated by the piezoelectric vibrating element 200. The vibration of the auricle 300 is transmitted to the eardrum 320, and thus the eardrum 320 vibrates. The vibration of the eardrum 320 is transmitted to the auditory ossicle 330, and thus the auditory ossicle 330 vibrates. The vibration of the auditory ossicle 330 is transmitted to the cochlea 340 and is converted into an electrical signal in the cochlea 340. The electrical signal is transmitted to the brain though the acoustic nerve 350 and the reception sound is recognized in the brain. In this manner, the tissue conduction sound is transmitted from the panel 4 to the user. FIG. 12 illustrates an auricle cartilage 300a in the inside of the auricle 300.

Bone conduction sound is a sound recognized in the human brain by the vibration of the skull and direct stimulation of the inner ear such as the cochlea caused by the vibration of the skull. In FIG. 12, in a case where a jawbone 500 vibrates, the transmission path of the sound signal while the bone conduction sound is recognized in the brain is indicated by a plurality of arcs 420.

As described above, in one embodiment, the air conduction sound and the tissue conduction sound can be transmitted from the panel 4 to the user of the electronic apparatus 1 due to an appropriate vibration of the panel 4 through the vibration of the piezoelectric vibrating element 200. The user can hear the air conduction sound from the panel 4 by moving the panel 4 close to an ear (auricle). Further, the user can hear the air conduction sound and the tissue conduction sound from the panel 4 by bringing the panel 4 into contact with an ear (auricle). The structure of the piezoelectric vibrating element 200 according to one embodiment is contrived to appropriately transmit the air conduction sound and the tissue conduction sound to the user. Various advantages are achieved by configuring the electronic apparatus 1 to transmit the air conduction sound and the tissue conduction sound to the user.

If there is a large amount of ambient noise, the user can make it difficult to hear the ambient sound by strongly putting the panel 4 to the ear while turning up the volume of the tissue conduction sound. Accordingly, the user can appropriately perform communication even when there is a large amount of the ambient noise.

In addition, even with earplugs or earphones on his/her ears, the user can recognize the reception sound from the electronic apparatus 1 by putting the panel 4 to the ear (more specifically, the auricle). Further, even with headphones on his/her ears, the user can recognize the reception sound from the electronic apparatus 1 by putting the panel 4 to the headphones.

Since the panel 4 is attached to the cover member 2, the vibration of the panel 4 causes the cover member 2 to vibrate. Thus, the air conduction sound and the tissue conduction sound are transmitted from the cover member 2 to the user. Accordingly, the user can hear the reception sound by moving the cover member 2 close to the ear or by bringing the cover member 2 into contact with an ear.

While the touch panel 130 and the display panel 120 has a gap therebetween as illustrated in FIG. 10 in one example mentioned above, the touch panel 130 and the display panel 120 may be in contact with each other. With a gap provided between the touch panel 130 and the display panel 120 as in one embodiment, the cover member 2 is less likely to apply pressure on the display panel 120 even when the cover member 2 is pressed by the user with the finger or the like and thus the cover member 2 is bent toward the display panel 120. Accordingly, the display of the display panel 120 is less likely to be disturbed due to the application of the pressure on the display panel 120 by the cover 2.

As described above, in the electronic apparatus 1 according to one embodiment, the piezoelectric vibrating element 200 is disposed in the portion (the panel 4 in one example) that vibrates more easily than the cover member 2. Thus, even if the cover member 2 is made of a hard material such as sapphire to eliminate or reduce damage to the cover member 2 or cracks of the cover member 2, the piezoelectric vibrating element 200 causes the part that vibrates more easily than the cover member 2 to vibrate, and accordingly the sound (the air conduction sound and the tissue conduction sound) from the electronic apparatus 1 can be easily transmitted to the user.

In a case where the piezoelectric vibrating element 200 is mounted on the panel 4 that vibrates more easily than the cover member 2 as in one embodiment, the use of the panel 4 as the design panel can improve the designability of the electronic apparatus 1.

Further, if the bonding material 220 is an elastic double-sided tape and the panel 4 is attached to the cover member 2 with the double-sided tape, the panel 4 vibrates more easily. Accordingly, the sound (the air conduction sound and the tissue conduction sound) form the electronic apparatus 1 can be transmitted to the user more easily. The elastic double-sided tape is, for example, a double-sided tape including a foam as a base material.

<Modification>

The outer surface 20 of the cover member 2 may be coated with a coating agent that prevents the adhesion of fingerprints. In this case, the adhesion of the panel 4 to the outer surface 20 is less likely to deteriorate if the coating agent is not applied to the portion of the outer surface 20 to which the panel 4 is attached.

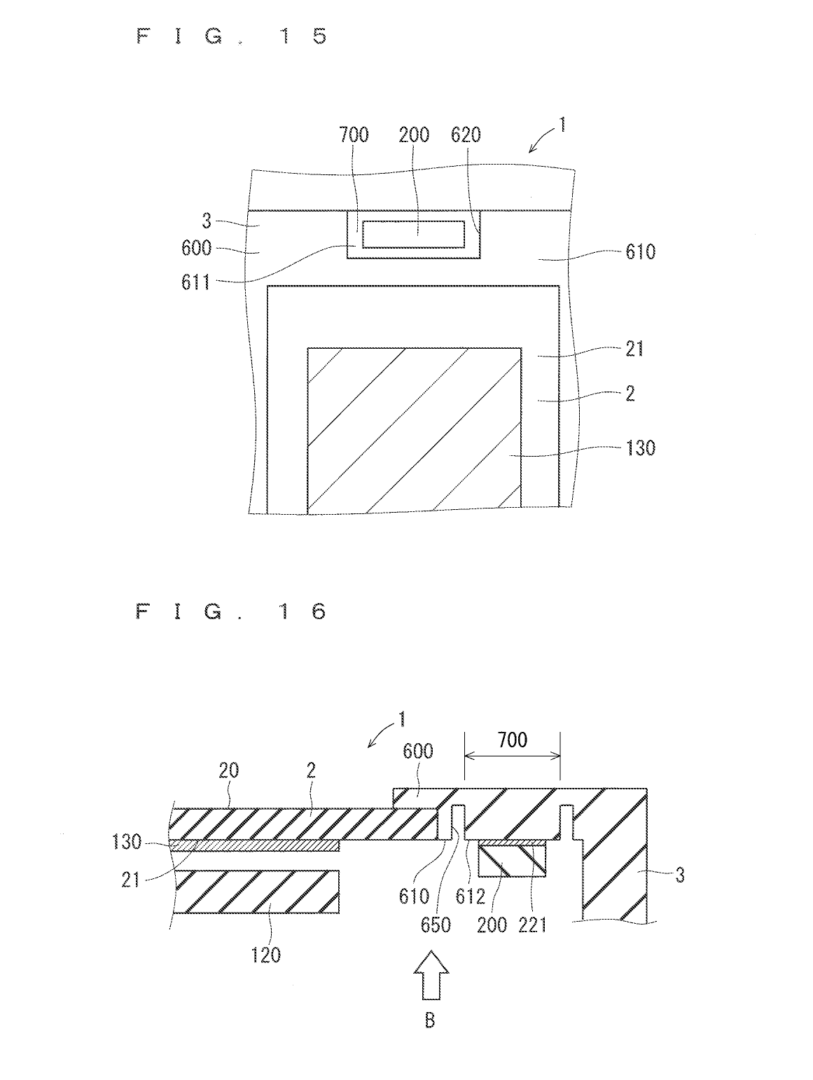

Further, as illustrated in FIG. 13, the portion of the outer surface 20 of the cover member 2 to which the panel 4 is attached may include a step (recess) such that the step between the outer surface 20 (specifically, the region of the outer surface 20 to which the panel 4 is not attached) and the front surface 4b of the panel 4 is decreased. In this case, the outer surface 20 and the front surface 4b of the panel 4 may be in the same plane.

The decrease in the step between the outer surface 20 of the cover member 2 and the front surface 4b of the panel 4 can reduce the occurrence in which the user finds it difficult to put the panel 4 to the ear due to the excessive projection of the front surface 4b of the panel 4. This also gives the user that the electronic apparatus 1 has a simplified front surface.

### Embodiment 2

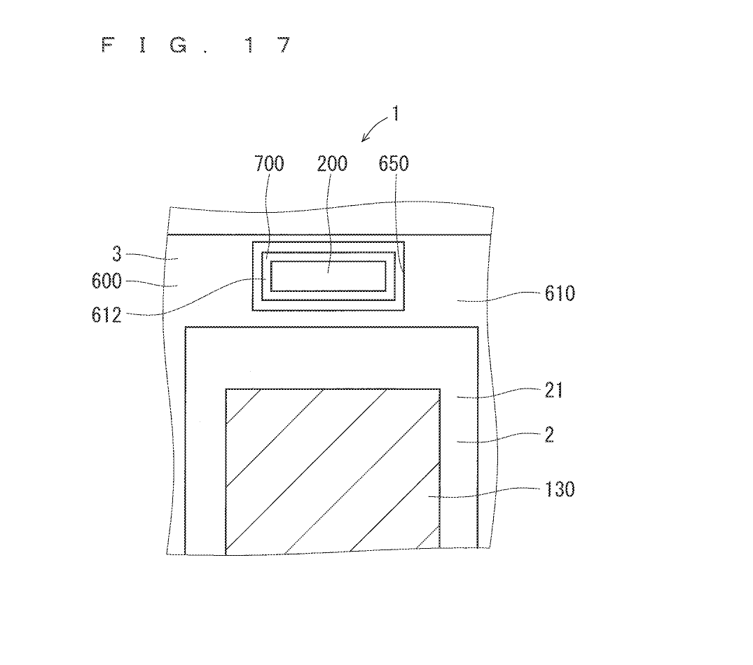

In the embodiment 1 mentioned above, the panel 4 includes the part that vibrates more easily than the cover member 2 with the piezoelectric vibrating element 200 being disposed on the part. Alternatively, the housing 3 may include such a part. That is, the piezoelectric vibrating element 200 may be disposed on the part of the housing 3 that vibrates more easily than the cover member 2. FIG. 14 illustrates a partially-enlarged sectional structure of the electronic apparatus 1 according to the embodiment 2. FIG. 14 is a cross-sectional view that corresponds to FIG. 11 described above. FIG. 15 is a plan view showing the structure illustrated in FIG. 14 when seen from the direction indicated by the arrow A. The display panel 120 is omitted from FIG. 15.

As illustrated in FIGS. 14 and 15, in the electronic apparatus 1 according to one embodiment, a portion 700 that vibrates more easily than the cover member 2 is located in a portion 600 (hereinafter referred to as a “front upper-end portion 600”) of the housing 3 that forms the upper end of the front portion of the electronic apparatus 1. The housing 3 includes a recessed portion 620 on an inner surface 610 of the front upper-end portion 600. The housing 3 has a reduced thickness in the part in which the recessed portion 620 is located. This portion is the portion 700 that vibrates more easily than the cover member 2. The thickness of the portion of the housing 3 in which the recessed portion 620 is located is set to be smaller than, for example, the thickness of the cover member 2. In one embodiment, for example, the cover member 2 and the housing 3 are integrally formed.

The piezoelectric vibrating element 200 is attached to a region 611, in which the recessed portion 620 is located, of the inner surface 610 of the front upper-end portion 600 of the housing 3 with the bonding material 221. In other words, the piezoelectric vibrating element 200 is attached to the bottom surface of the recessed portion 620 with the bonding material 221.

As described above, in one embodiment as well, the piezoelectric vibrating element 200 is disposed in the portion 700 that vibrates more easily than the cover member 2. The piezoelectric vibrating element 200 causes the portion 700 to vibrate, and accordingly the sound (the air conduction sound and the tissue conduction sound) from the electronic apparatus 1 can be easily transmitted to the user.

As in one embodiment, the portion 700 that vibrates more easily than the cover member 2 is located in the housing 3, thus eliminating the need for the panel 4 mentioned above. The cost of the electronic apparatus 1 can be accordingly reduced.

<Modification>

In one example mentioned above, the housing 3 includes the recessed portion 620 on the inner surface 610 of the front upper-end portion 600, and thus the housing 3 includes the portion 700 that vibrates more easily than the cover member 2. Alternatively, the housing 3 may include the portion 700, which vibrates more easily than the cover member 2, in a different manner.

For example, the inner surface 610 of the front upper-end portion 600 of the housing 3 may be provided with a groove 650 which surrounds a part of the inner surface 610 such that the portion 700 that vibrates more easily than the cover member 2 is located in the housing 3. FIG. 16 illustrates a partially-enlarged sectional structure of the electronic apparatus 1 in this case. FIG. 17 is a plan view showing the structure illustrated in FIG. 16 when seen from the direction indicated by the arrow B. The display panel 120 is omitted from FIG. 17.

As illustrated in FIGS. 16 and 17, in the electronic apparatus 1 according to one modification, the inner surface 610 of the front upper-end portion 600 of the housing 3 is provided with the groove 650 that surrounds a part of the inner surface 610. The thickness of the portion of the housing 3 in which the groove 650 is formed is set to be smaller than the thickness of, for example, the cover member 2. In one modification, the portion of the housing 3 surrounded by the groove 650 is the portion 700 that vibrates more easily than the cover member 2. The thickness of the portion of the housing 3 surrounded by the groove 650, in other words, the thickness of the portion 700 that vibrates more easily than the cover member 2 is set to be greater than the thickness of, for example, the cover member 2.

The piezoelectric vibrating element 200 is attached to a region 612, which is surrounded by the groove 650, of the inner surface 610 of the front upper-end portion 600 of the housing 3 with the bonding material 221. In other words, the piezoelectric vibrating element 200 is attached to the inner surface of the portion, which is surrounded by the grove 650, of the front upper-end portion 600 of the housing 3 with the bonding material 221.

As described above, in one modification as well, the piezoelectric vibrating element 200 is disposed in the portion 700 that vibrates more easily than the cover member 2. The piezoelectric vibrating element 200 causes the portion 700 to vibrate, and accordingly the sound (the air conduction sound and the tissue conduction sound) from the electronic apparatus 1 can be easily transmitted to the user.

The portion 700 that vibrates more easily than the cover member 2 is located in the housing, thus eliminating the need for the panel 4. The cost of the electronic apparatus 1 can be accordingly reduced.

In one embodiment, the portion of the housing 3 surrounded by the grove 650 is the portion 700 that vibrates more easily than the cover member 2, and therefore, the thickness of the portion to which the piezoelectric vibrating element 200 is attached can be greater than the thickness of the corresponding portion of the electronic apparatus 1 illustrated in FIGS. 14 and 15. This can reduce the occurrence of breakage of the piezoelectric vibrating element 200 if the electronic apparatus 1 is dropped.

In the above description, although embodiments of the present disclosure are applied to mobile phones, embodiments of the present disclosure are also applicable to other electronic apparatuses in addition to the mobile phones.

In the above description, the electronic apparatus 1 is described in detail, but the above description is the exemplification in all aspects and embodiments of the present disclosure are not intended to be limited thereto. In addition, various examples described above are applicable in combination as long as they are not mutually inconsistent. And, it is construed that numerous modifications which are not exemplified can be envisaged without departing from the scope of the present disclosure.

1. An electronic apparatus comprising:
a display;
a cover member that is located on a surface of the electronic apparatus and is configured to cover a display surface of the display;
a first portion that is located on the surface of the electronic apparatus and is configured to vibrate more easily than the cover member;
a piezoelectric vibrating element located on the first portion; and
a controller configured to cause the piezoelectric vibrating element to vibrate based on a sound signal.

2. The electronic apparatus according to claim 1, comprising
a panel attached to the cover member,
wherein the panel includes the first portion.

3. The electronic apparatus according to claim 2, wherein the panel is attached to the cover member with an elastic double-sided tape.

4. The electronic apparatus according to claim 1, comprising
a housing configured to accommodate the display, the piezoelectric vibrating element, and the controller,
wherein the housing includes the first portion.

5. The electronic apparatus according to claim 4, wherein
the housing includes a recessed portion on a surface thereof, and
a second portion of the housing in which the recessed portion is located is the first portion.

6. The electronic apparatus according to claim 4, wherein
the housing includes a groove formed on a surface thereof, and
a second portion of the housing surrounded by the groove is the first portion.

7. The electronic apparatus according to claim 1, wherein the piezoelectric vibrating element causes the first portion to vibrate such that air conduction sound and tissue conduction sound are transmitted to a user from the first portion.

8. The electronic apparatus according to claim 1, wherein
the cover member comprises glass or sapphire, and
the first portion is made of resin.

9. The electronic apparatus according to claim 1, wherein the cover member has a Young's modulus greater than that of the first portion.
